(19) United States
(12) Patent Application Publication
(10) Pub. No.: US 2007/0299774 A1
(43) Pub. Date: Dec. 27, 2007

(54) SYSTEM AND METHOD FOR CARD NOT PRESENT TRANSACTIONS

(75) Inventor: Grant Eaves, Essex (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/425,951

(22) Filed: Jun. 22, 2006

(51) Int. Cl. G06Q 40/00; G06Q 30/00

(52) U.S. Cl. 705/40; 705/15

(57) ABSTRACT

An authorizing system used for credit card and similar transactions where the credit card is not physically presented to the merchant (i.e., “card not present” transactions). Authorizing criteria may be selected by the account holder and stored in the authorizing system, for comparison to subsequent “card not present” transactions. The authorizing criteria may include total cumulative transactions amounts for “card not present” transactions during a monthly statement period.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The use of credit cards and similar instruments has grown enormously, particularly for Internet, telephone and other transactions where the card holder does not physically present the card to a merchant when conducting a transaction.

Such “card not present” transactions may be more prone to fraud, inasmuch as the cardholder is not physically present for the merchant to verify cardholder identity or to obtain a signature for authentication.

While merchants may reduce fraud by limiting or eliminating altogether “card not present” transactions, such an approach is not feasible for on-line merchants.

On-line merchants may require the customer to provide, in addition to the account number from the front of the card, a security code (often a three or four digit code that appears on the back of the card), as a means to verify that the person conducting the transaction is in actual possession of the card. However, such an arrangement is not effective to prevent fraud if the impersonator has improperly obtained the card or otherwise managed to obtain the security code.

There has thus arisen the need for systems to limit the financial losses to both merchants and cardholders from fraudulent transactions where an impersonator has managed to obtain the cardholder card number and uses the same to conduct unauthorized transactions.

### BRIEF SUMMARY OF THE INVENTION

There is provided, in accordance with embodiments of the present invention, a system and method for reducing fraudulent “card not present” transactions by permitting a cardholder to establish advance restrictions in connection with such transactions.

In one embodiment, the system includes a terminal for entering transaction data pertaining to the transaction being conducted, and an authorizing system. The authorizing system includes a database storing authorizing data representing authorization criteria collected in advance from the account holder and defining “card not present” transactions that are to be authorized, and a processor for receiving the transaction data from the terminal, for accessing the authorizing data from the database, and for applying the authorizing data to the transaction data to determine if the transactions is to be authorized.

A more complete understanding of the present invention may be derived by referring to the detailed description of the invention and to the claims, when considered in connection with the Figures.

### BRIEF DESCRIPTION OF THE DRAWINGS

In the Figures, similar components and/or features may have the same reference label. Further, various components of the same type may be distinguished by following the reference label with a supplemental character that distinguishes among the similar components. If only the reference label is used in the specification, the description is applicable to any one of the similar components having the same reference label irrespective of the supplemental character.

FIG. 1 is a general schematic diagram illustrating a system in accordance with an embodiment of the invention.

FIG. 2 is a general schematic diagram of an authorization system used in the system of FIG. 1.

FIG. 3 is a flow diagram illustrating program steps of a method carried out within the system of FIG. 1.

FIG. 4 illustrates a computer screen used in selecting “card not present” criteria or restrictions in accordance with an embodiment of the invention.

### DETAILED DESCRIPTION OF THE INVENTION

Embodiments of the present invention are directed to authorizing transactions that are referred to herein as “card not present” transactions. Such transactions are conducted using a cardholder account, but for various reasons, the cardholder is not able to physically present the card to a merchant. As examples, the cardholder may be conducting the transaction over the Internet or via phone. Also, while the term “card” is used herein, and in the described embodiment a transaction is illustrated with reference to a credit card, it should be appreciated that the invention has applicability to other kinds of presentation instruments (e.g., gift cards, stored value cards, and other instruments or devices that may bear account data). Thus the present invention may be used with any instrument or device when the account holder desires to conduct a transaction without being able to personally present the instrument to a merchant.

Generally, the present invention is implemented by a cardholder establishing criteria in advance for “card not present” transactions. The criteria are captured from the cardholder and stored so as to be electronically accessible when a transaction is conducted, and are in addition to other restrictions that might be placed on the account. Such criteria are distinct from normal criteria or restrictions that govern the general use of a payment instrument, such as whether a transaction will cause a balance or credit limit to be exceeded. Instead, “card not present” criteria are specifically directed to instances where a transaction is conducted without the card being physically presented to the merchant. When a purchaser of goods and/or services identifies the payment instrument in such a transaction, an authorization system checks the associated “card not present” criteria to determine whether the transaction is consistent with the criteria. If the purchaser is attempting to purchase goods and/or services inconsistent with or outside the limits of the criteria, the transaction may be denied.

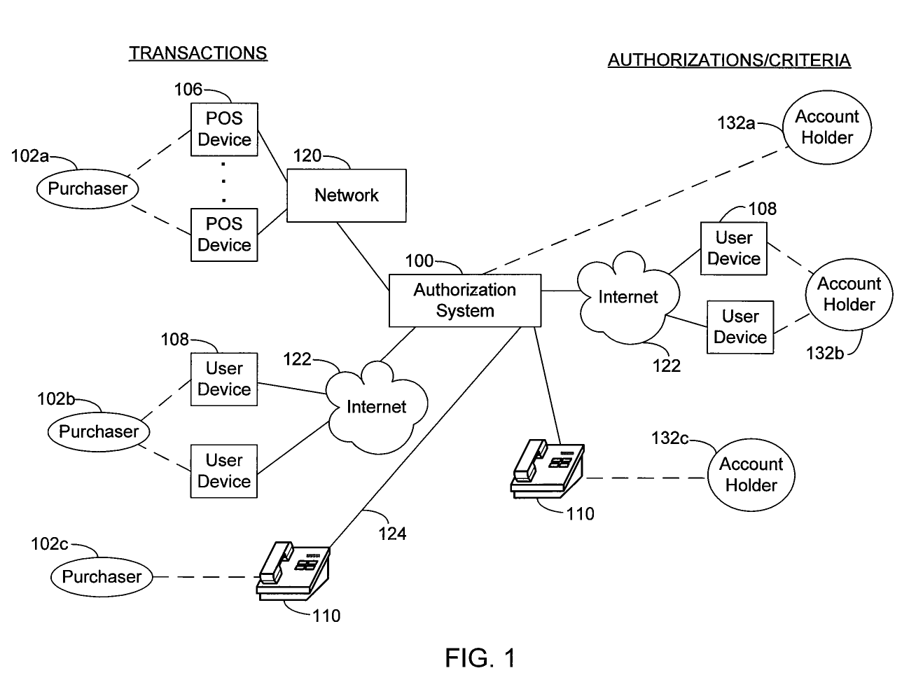

There are various embodiments and configurations for implementing the present invention. One such implementation is shown in FIG. 1, where according to an embodiment of the invention, an authorization system 100 is used for authorizing transactions that may be conducted by purchasers 102. As seen generally on the left hand side in FIG. 1 (under the heading “Transactions”), transactions may be conducted in some instances by purchasers 102a at conventional point-of-sale (POS) devices 106 that are located at retail establishments or the like. In other instances, transactions may be conducted remotely from the merchant by purchasers 102b at user devices 108 (e.g., a personal computer located at a purchaser's home), or by purchasers 102c using telephone devices 110. In each instance, data from the transaction is presented to the authorization system 100. For example, the data at POS devices 106 may be transmitted to the authorization system 100 through a retail network 120, the data from the user devices 108 may be transmitted though a network 122 (e.g., the Internet), and voice or telephone transactions may be provided over a telephone line 124 (e.g., using a interactive voice response feature or module within the system 100, not shown). As will be described in greater detail below, embodiments of the invention are directed to transactions where a credit card or other payment instrument is used by the purchaser 102 to make payment, but the card is not physically presented to the merchant. This is normally the case when a user device 108 or telephone 110 is used for the transaction, although there may also be circumstances when such a transaction is conducted at a POS device 106.

Transaction criteria are established by the cardholder/account holder for “card not present” transactions and are stored in advance in the authorizing system 100. Accordingly, as illustrated on the right hand side of FIG. 1 (under the heading “Authorizations/Criteria”), some account holders 132a may establish the criteria directly with the authorizing system (e.g., in person instructions during a visit to a credit card or bank office where input devices to the authorizing system 100 are located), other account holders 132b may provide such criteria using user devices 108 (over the Internet), and yet other account holders 132c may use a telephone 110. It should be appreciated that in most instances the account holder 132 establishing the transaction criteria is the same person as the purchaser 102 subsequently making purchases against which the criteria are applied, although there may be some circumstances where that is not the case. As one example of where the account holder and the purchaser may be different, a primary cardholder may establish criteria for “card not present” transactions, and different secondary cardholders (family members) may use the card as purchasers 102.

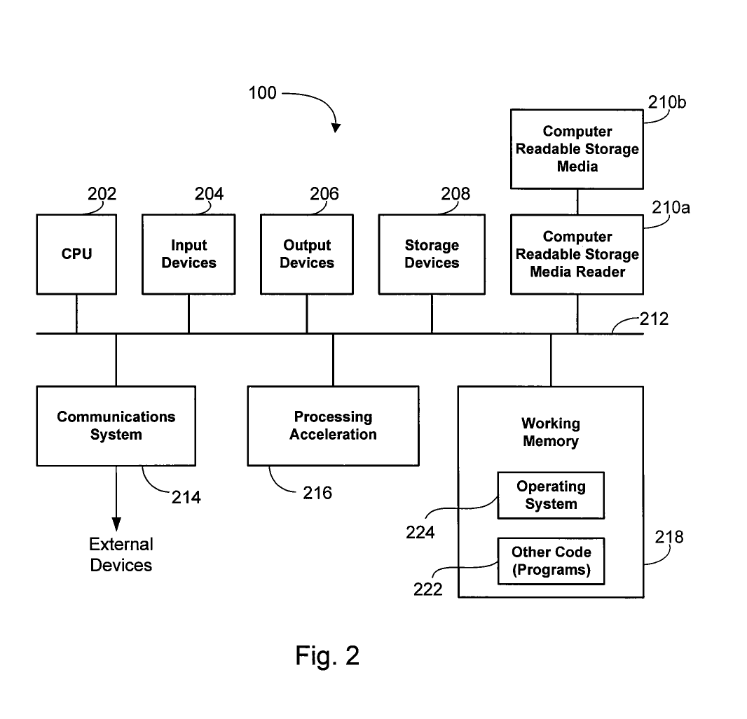

A structure for the authorization system 100 in one embodiment is shown schematically in FIG. 2, in which methods of the invention are implemented on a computer system. This figure broadly illustrates how individual system elements may be integrated. The authorization system 100 is shown comprised of hardware elements that are electrically coupled via bus 212, including a processor (CPU) 202, input devices 204 (e.g., keyboards operated by administrative personnel), output devices 206 (e.g., video display, printer, etc.), storage devices 208, a computer-readable storage media reader 210a, a communications system 214 (for communicating with external devices), a processing acceleration unit 216 such as a DSP or special-purpose processor, and a working memory 218. The computer-readable storage media reader 210a is further connected to a computer-readable storage medium 210b, the combination comprehensively representing remote, local, fixed, and/or removable storage devices plus storage media for temporarily and/or more permanently containing computer-readable information. Data representing transaction criteria used for authorizing “card not present” transactions may be stored either in storage devices 208 or storage media 210b. The communications system 214 may comprise a wired, wireless, modem, and/or other type of interfacing connection and permits data to be exchanged between the authorization system 100 and external devices, such as point-of-sale devices 106, user devices 108, and telephones 110.

When data representing transaction criteria is provided by an account holder, it passes through communications system 214 for storage in authorizing system 100, under control of processor 202. Likewise, when data reflecting specific transactions are provided by external devices for authorization, it passes through communications system 214 for comparison within authorization system 100 to stored criteria data, also under the control of processor 202.

The authorization system 100 also comprises software elements, shown as being located within working memory 218, including an operating system 224 and other code 222, such as a program designed to implement methods of the invention. It will be apparent to those skilled in the art that substantial variations may be used in accordance with specific requirements. For example, in some instances, customized hardware might also be used to implement functions. In other instances, particular elements might be implemented in hardware or software (including portable software, such as applets), or both. Further, connection to other computing devices such as network input/output devices may be employed.

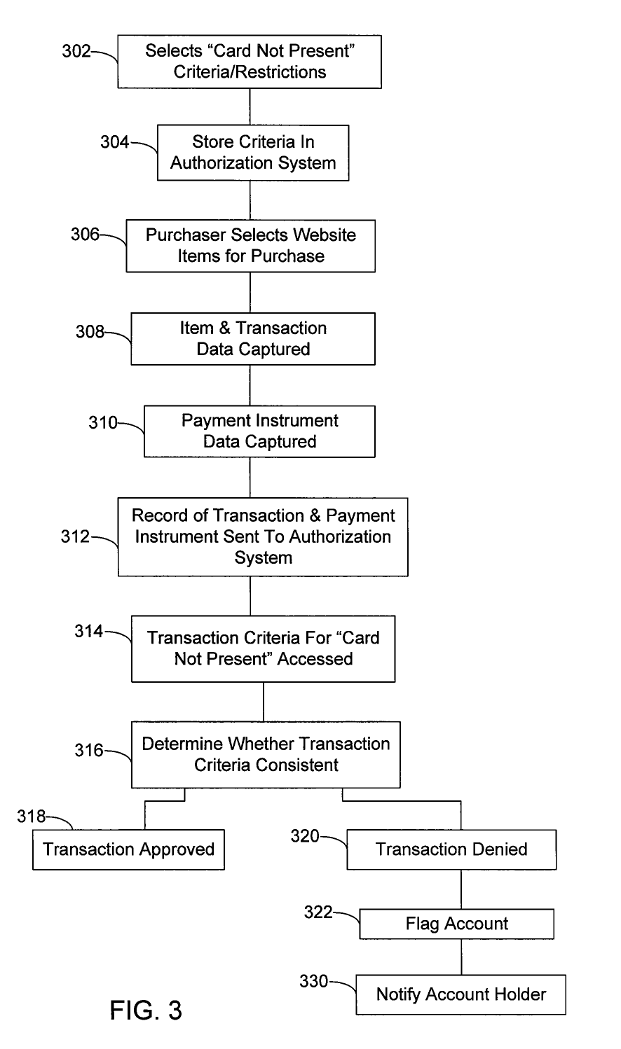

FIG. 3 illustrates one embodiment of a process for “card not present” transaction criteria to be established for an account and then subsequently applied against transactions conducted against the account.

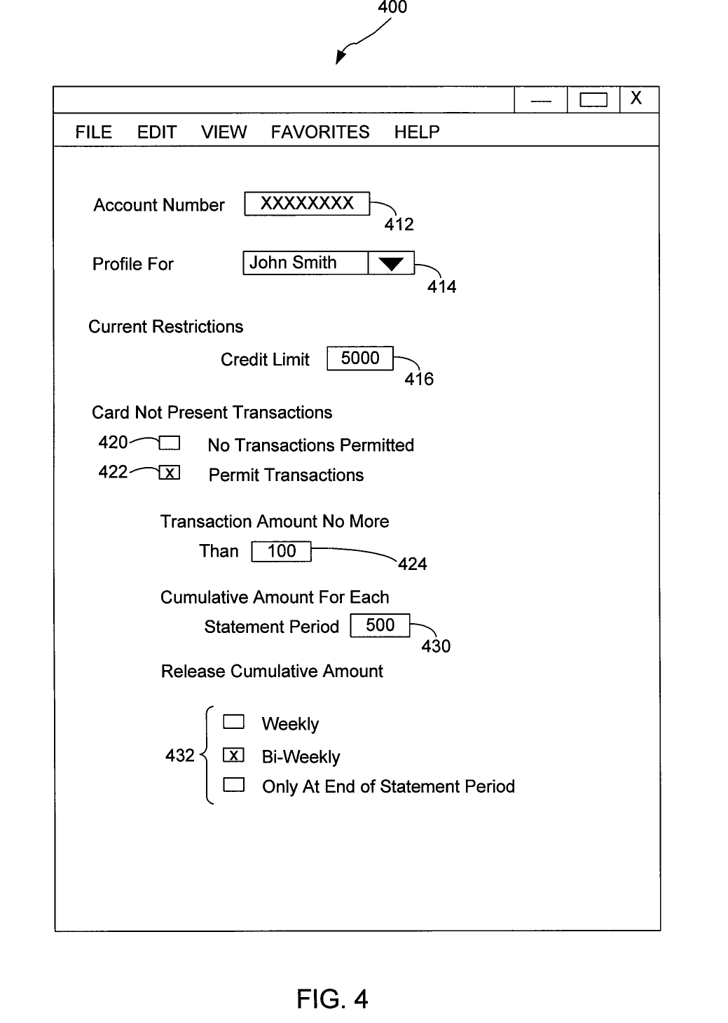

At step 302, an account holder initially selects criteria that are to be used in authorizing “card not present” transactions. Examples of such criteria will be described below in conjunction with FIG. 4. However, briefly, one such criteria could be a monthly monetary limit on such transactions, which the account holder might select, e.g., based on anticipated Internet transactions during a monthly statement period. Criteria could be selected when the account is first established, and also could be selected or changed from time to time as the spending habits of the account holder change. After selection, the criteria are entered at one of various input devices (e.g., user device 108, telephone device 110) in order to be stored within the authorizing system 100 (step 304). Thereafter the criteria may be used in authorizing specific transactions that are conducted against the account (without the card being present).

When a “card not present” transaction is to be conducted, the purchaser/account holder selects items to be purchased (step 306), which in the illustrated process are offered for sale on a merchant website. The item(s) selected and other transaction data (e.g., purchase price) may be captured by filling in or highlighting appropriate fields on a screen displayed at the website (step 308), and payment instrument data (e.g., credit card account number) is likewise captured, such as by entering the account number on the website screen (step 310).

A data record of the transaction and account number are sent to the authorizing system 100 (step 312) before the transaction is completed. In response, the authorizing system 100 accesses the transaction criteria data that has been stored for that account (step 314), and the system determines whether the transaction criteria are consistent with the transaction being conducted (step 316). For example, if one criteria is the total amount of “card not present” transactions that may be conducted during a monthly period, then the transaction amount could be added to previous transactions during that month and the total compared to the criteria to make sure the maximum permitted amount has not been exceeded.

If the transaction is consistent with the pre-established criteria, then the transaction moves onto the next stage, i.e., the recognised authorization process for approval (step 318). However, if the transaction is not consistent (e.g., maximum transaction total is exceeded for “card not present” transactions), then the transaction is denied (step 320). Not only is the denial reflected at the website where the transaction was attempted, but the account is flagged (step 322), so that the account holder can be notified at step 330 (e.g., by a separate email or letter to the account holder). This alerts the account holder of the denial so that if in fact the transaction was attempted by an unauthorized person having the account number, the account holder can confirm the fraudulent activity to the credit card company and either close the account or have activity on the account suspended pending an investigation.

FIG. 4 illustrates a website screen 400 that may be displayed to an account holder to review, select or change transaction criteria. As illustrated, the user enters his/her account number at field 412, with the account holder name then displayed for confirmation at field 414. There could be a drop down button or feature at field 414 to display the names of other, secondary account holders (e.g., family members). The screen 400 may display existing account features or restrictions that may be general and not specifically related to “card not present” transactions, such as the account credit limit at field 416. While the screen is intended for the purpose of selecting “card not present” criteria, the screen could be also used for the account holder to select/change general account features as well.

The account holder may view and change the “card not present” criteria, by selecting appropriate boxes and making data entries. For example, the account holder may decide whether or not any “card not present” transactions are to be permitted (boxes 420, 422). If such transactions are permitted, then the total amount of any individual transaction could be selected at box 424 (by entering a monetary amount, e.g., $US or £UK).

In one embodiment of the invention, the account holder may select a cumulative amount for each statement period (i.e., monthly) for the total amount of “card not present” transactions that are to be permitted, by entering such cumulative amount at box 430. In addition, and as extra protection, the account holder may also indicate that such amount is to be reset or released at specified intervals within the statement period (e.g., weekly or bi-weekly) at boxes 432. This last mentioned feature assures the account holder that even if the monthly amount has not been exceeded, if during a shorter interval (e.g., bi-weekly) the pro-rated amount of the monthly maximum is exceeded, the transaction is declined and the account holder is alerted to prevent the entire monthly amount from being used up by an impersonator before being brought to the account holder's attention.

While a detailed description of presently preferred embodiments of the invention has been given above, various alternatives, modifications, and equivalents will be apparent to those skilled in the art without varying from the spirit of the invention. For example, while the “card not present” transaction criteria in FIG. 4 are illustrated as an individual transaction limit and as a cumulative statement period limit, various other criteria/restrictions are possible, such as restrictions relating to the goods being purchased, the time of the day of the purchase, and so forth. Therefore, the above description should not be taken as limiting the scope of the invention, which is defined by the appended claims.

What is claimed is:

1. A system for authorizing a “card not present” transaction conducted by an account holder, the system comprising:
a terminal for entering transaction data pertaining to the transaction being conducted;
a database storing authorizing data representing authorization criteria captured in advance from the account holder and defining “card not present” transactions that are to be authorized; and
a processor for receiving the transaction data from the terminal, for accessing the authorizing data from the database, and for applying the authorizing data to the transaction data to determine if the transactions is to be authorized.

2. The system of claim 1, wherein the authorization criteria is captured from the account holder using a website screen.

3. The system of claim 2, wherein the transaction data is captured at a user device located remotely from a merchant.

4. The system of claim 3, wherein the user device comprises a personal computer.

5. The system of claim 2, wherein the website screen permits the account holder to view previously selected authorization criteria.

6. The system of claim 2, wherein the website screen enables the account holder to enter authorization criteria that establish a total cumulative monetary amount of “card not present” transactions that may be authorized during a predetermined period of time.

7. The system of claim 6, wherein the predetermined period of time is a monthly statement period.

8. The system of claim 6, wherein the website screen further permits the account holder to enter a second cumulative monetary amount of transactions, the second amount establishing a cumulative amount of “card not present” transactions that may be authorized during a second predetermined period of time having a length of time that is shorter than the monthly statement period.

9. The system of claim 1, wherein the transaction data comprises an account number and a transaction amount.

10. The system of claim 1, wherein the terminal comprises one of a POS terminal, user device and a telephone device.

11. A method for authorizing a transaction with a merchant and against a presentation instrument account, when the transaction is conducted without the presentation instrument being physically presented to the merchant, the method comprising:
entering authorizing data into a database in advance of the transaction, where the data represents authorizing criteria selected by an account holder for determining whether transactions are permitted against the account when the instrument is not physically presented to the merchant;
entering transaction data representing characteristics of a transaction to be conducted against the account, wherein the instrument is not physically presented to the merchant; and
using a processor to compare the authorizing data to the transaction data, and authorizing the transaction only if the transaction data is consistent with the authorizing data.

12. The method of claim 11, wherein the presentation instrument comprises a credit card.

13. The method of claim 12, wherein the transaction data is entered at a user device that is remote from the merchant.

14. The method of claim 12, wherein the user device comprises a personal computer, wherein the processor is part of an authorizing system that includes a database for storing the authorizing data, and wherein the user device communicates with the authorizing system over the Internet.

15. The method of claim 12, wherein the authorizing criteria comprises a total cumulative monetary amount of transactions that may be conducted during a predetermined period of time, wherein such transactions are conducted without physical presentation of the presentation instrument to the merchant.

16. The method of claim 15, wherein the predetermined period of time is a monthly statement period.

17. The method of claim 16, wherein the authorization criteria further comprises a second cumulative monetary amount of transactions, the second amount establishing a cumulative amount of “card not present” transactions that may be authorized during a second predetermined period of time having a length of time that is shorter than the monthly statement period.

18. The method of claim 16, wherein the authorization criteria further comprises a maximum transaction amount that may not be exceeded for any individual transaction conducted without physical presentation of the presentation instrument to the merchant.

19. The method of claim 11, wherein transaction data includes an account number and a transaction amount.

20. The method of claim 11, further comprising:
communicating an alert to the account holder if the transaction data is not consistent with the authorizing data.
